(19) United States
(12) Patent Application Publication
(10) Pub. No.: US 2024/0420436 A1
(43) Pub. Date: Dec. 19, 2024

(54) ELECTRONIC SYSTEM FOR PERFORMING CONTROL OVER VIRTUAL REALITY SPACE, ELECTRONIC DEVICE, AND METHOD FOR OPERATING SAME

(71) Applicant: Korea Advanced Institute of Science and Technology, Daejeon, Yuseong-Gu (KR)

(72) Inventors: Seok Hyung BAE, Daejeon (KR); Joon Hyub LEE, Daejeon (KR); Jae Ho SUNG, Daejeon (KR); Dong Hyeok MA, Daejeon (KR); Han Bit KIM, Daejeon (KR); Sang Hyun LEE, Daejeon (KR)

(73) Assignee: Korea Advanced Institute of Science and Technology, Daejeon, Yuseong-Gu (KR)

(21) Appl. No.: 18/698,380

(22) PCT Filed: Dec. 2, 2021
(86) PCT No.: PCT/KR2021/018158

§ 371 Date: Apr. 4, 2024

(30) Foreign Application Priority Data
Oct. 6, 2021 (KR) 10-2021-0132570
Dec. 1, 2021 (KR) 10-2021-0169670

(51) Int. Cl. G06T 19/20; G02B 27/01; G06F 3/01; G06T 11/20

(52) U.S. Cl. CPC G06T 19/20; G02B 27/017; G06F 3/012; G06F 3/017; G06T 11/203; G06T 2219/2004; G06T 2219/2016

(57) ABSTRACT

Disclosed are an electronic system for performing control over a virtual reality space, an electronic device, and a method for operating same. The disclosed electronic system comprises: an electronic device which receives, as one or more touch gestures, control of a virtual reality space and/or an object within the virtual reality space and displays a first screen according to a corresponding first view frustum within the virtual reality space; and an HMD which is worn on the user's head and displays a second screen of the virtual reality space according to the head direction of the user at a time point corresponding to the second view frustum within the virtual reality space.

### TECHNICAL FIELD

The following description relates to an electronic system for performing control over a virtual reality space, an electronic device, and a method for operating the same.

### BACKGROUND ART

Virtual reality (VR) refers to a virtual world that is not real but created using computers, etc., and the recent development of virtual reality technology allows users to have various experiences in the virtual reality space. Also, users may interact with other users in virtual reality.

### DISCLOSURE OF THE INVENTION

### Technical Solutions

According to an embodiment, an electronic system includes an electronic device configured to receive, as one or more touch gestures, control of a virtual reality space and/or an object within the virtual reality space, and display a first screen according to a corresponding first view frustum within the virtual reality space, and a head-mounted display (HMD) configured to be worn on a head of a user and to display a second screen of the virtual reality space according to a direction of the head of the user from a viewpoint corresponding to a second view frustum within the virtual reality space, wherein a virtual display of the electronic device displayed on the second screen according to the direction of the head may be synchronized to an actual display of the electronic device, and when the user performs a motion of inputting one or more touch gestures into the virtual display displayed on the second screen, the one or more touch gestures may be input into the actual display of the electronic device so that control of the virtual reality space and/or the object may be performed.

The virtual display of the electronic device displayed on the second screen may display the first screen displayed on the actual display of the electronic device.

One or a combination of at least two of a size, a position, and an orientation of the virtual display of the electronic device displayed on the second screen may be synchronized with that of the actual display of the electronic device.

A hand of the user being tracked may be displayed together with the virtual display of the electronic device on the second screen, and a touch gesture may be input into the actual display with a motion of the user inputting the touch gesture into the virtual display.

The electronic device may perform moving and/or rotating the first view frustum within the virtual reality space based on the one or more touch gestures input from the user, and the moving and/or rotating of the first view frustum may be performed within a preset boundary within the virtual reality space.

The electronic device may perform a sketch on a screen plane of the first view frustum within the virtual reality space based on a pen drawing input into the actual display, and display the sketched screen plane as the first screen.

The electronic device may perform one or a combination of at least two of moving, rotating, and resizing the object on the screen plane based on one or more touch gestures on an object generated by the sketch.

The electronic device may determine a projection plane of an object generated by the sketch based on a viewing direction of the first view frustum when performing the sketch.

The electronic device may generate the object on the projection plane and place the generated object in the virtual reality space when a command to generate the object is input from the user.

The electronic device may, based on one or more touch gestures on a card including an object within the virtual reality space, perform one or a combination of at least two of moving, rotating, and resizing the object on a first reference plane in which the card is included.

The electronic device may, based on one or more touch gestures on a stand of a card including an object within the virtual reality space, perform moving and/or rotating the object on a second reference plane in which the stand is included, and the stand may be generated to be parallel to a bottom of the virtual reality space at a position at which the card is projected onto the bottom of the virtual reality space.

The electronic device may, while a first touch gesture on a stand of a card including an object within the virtual reality space is input, control a height of the card within the virtual reality space based on a second touch gesture on the card.

The electronic device may, while a first touch gesture on a stand of a card including an object within the virtual reality space is input, perform rotating the object based on a second touch gesture on an area other than the card or the stand.

One or a combination of at least two of moving, rotating, and resizing the object according to one or more touch gestures input from the user may be performed within a preset boundary within the virtual reality space.

The first screen and/or the second screen may display a third view frustum corresponding to a second electronic device accessing the virtual reality space in a viewing direction of the third view frustum at a position corresponding to the second electronic device.

The first screen and/or the second screen may, in response to a sketch being performed on a second screen plane of the third view frustum based on a pen drawing input into an actual display of the second electronic device, display the sketched second screen plane.

The electronic device may, based on one or more pinch gestures on an object placed within the virtual reality space, input from the user wearing the HMD, perform one or a combination of at least two of moving, rotating, and resizing the object.

According to an embodiment, a method for operating an electronic device includes displaying a first screen according to a first view frustum corresponding to the electronic device within a virtual reality space, and receiving, as one or more touch gestures, control of the virtual reality space and/or an object within the virtual reality space, wherein in response to an HMD being worn on a head of a user who controls the electronic device, the HDM may display a second screen of the virtual reality space according to a direction of the head of the user from a viewpoint corresponding to a second view frustum within the virtual reality space, a virtual display of the electronic device displayed on the second screen according to the direction of the head may be synchronized to an actual display of the electronic device, and when the user performs a motion of inputting one or more touch gestures into the virtual display displayed on the second screen, the one or more touch gestures may be input into the actual display of the electronic device so that control of the virtual reality space and/or the object may be performed.

### Effects

According to an embodiment, a user may easily generate and control objects in a virtual reality space through touch gestures and pen drawings. In addition, the user may easily perform control of a corresponding view frustum in the virtual reality space through one or more touch gestures.

According to an embodiment, as an actual display of an electronic device and a virtual display of the electronic device displayed on a head-mounted display (HMD) are synchronized with each other, the virtual display displayed on the HMD displays a screen displayed on the actual display of the electronic device, and the virtual display of the electronic device and tracked hands of the user are displayed on the HMD, the user may input, without a sense of difference, touch gestures into the actual display of the electronic device through a motion of the user inputting touch gestures into the virtual display.

### BRIEF DESCRIPTION OF DRAWINGS

FIG. 1 is a diagram illustrating an electronic device according to an embodiment.

FIG. 2 is a drawing illustrating a virtual reality space and an object in the virtual reality space according to an embodiment.

FIGS. 3 to 5 are examples of operations related to camera manipulation according to an embodiment.

FIGS. 6 to 11 are examples of operations related to object generation according to an embodiment.

FIGS. 12 to 17 are examples of operations related to an object generated vertically to the bottom of a virtual reality space according to an embodiment.

FIGS. 18 to 23 are examples of operations related to an object generated horizontally to the bottom of a virtual reality space according to an embodiment.

FIGS. 24 and 25 are examples of operations related to the manipulation of a card including an object according to an embodiment.

FIG. 26 is an example of an operation related to multiple users according to an embodiment.

FIGS. 27 to 29 are examples of operations related to a head-mounted display (HMD) according to an embodiment.

FIG. 30 is a diagram illustrating a method for operating an electronic device according to an embodiment.

### BEST MODE FOR CARRYING OUT THE INVENTION

The following detailed structural or functional description is provided as an example only and various alterations and modifications may be made to the embodiments. Here, the embodiments are not construed as limited to the disclosure and should be understood to include all changes, equivalents, and replacements within the idea and the technical scope of the disclosure.

Terms, such as first, second, and the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component.

As used herein, the singular forms “a”, “an”, and “the” include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, embodiments will be described in detail with reference to the accompanying drawings. When describing the embodiments with reference to the accompanying drawings, like reference numerals refer to like components, and any repeated description related thereto will be omitted.

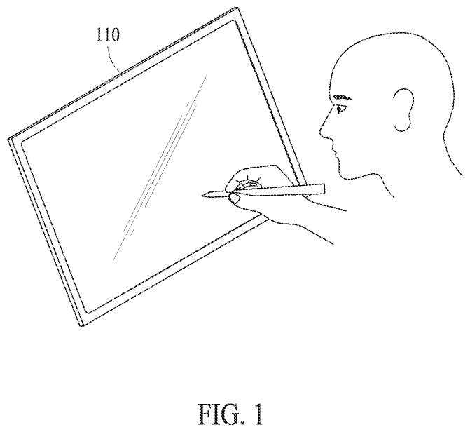

FIG. 1 is a diagram illustrating an electronic device according to an embodiment.

According to an embodiment, an electronic device 110 may allow an object to be sketched in three-dimensional virtual reality space based on a motion (e.g., a touch gesture and/or a hand motion, etc.) of the body of a user and/or a pen drawing. For example, the electronic device 110 may be implemented in the form of a tablet, but is not limited to the foregoing example. Through the electronic device 110, the user may place the sketched object in the three-dimensional virtual reality space, control the position, size, rotation, and the like of the object within the virtual reality space, and view the object from various viewpoints by controlling the angle of a camera viewing the object placed within the virtual reality space. Through these controls, the user may sketch, place, and move various objects within the three-dimensional virtual reality space and observe the objects from different angles, thereby having various experiences different from those in a real world space.

The electronic device 110 may include a display and/or a sensor. The display may receive a touch gesture and a pen input from the user. The display may be a touchscreen that may receive a touch gesture or a pen drawing from the user. The sensor may detect a hand motion of the user, and may detect, as described below, the position and/or orientation of a head-mounted display (HMD) when the user is wearing the HDM.

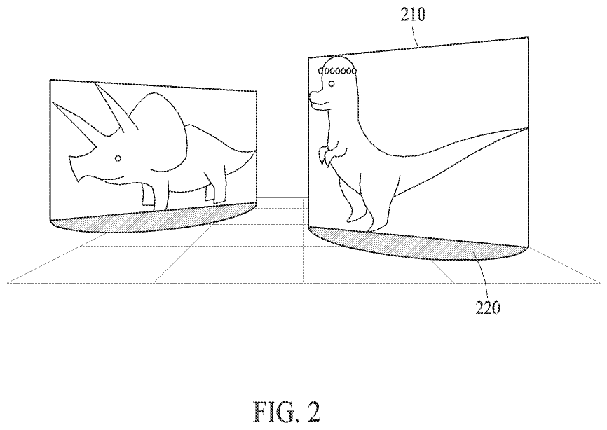

FIG. 2 is a drawing illustrating a virtual reality space and an object in the virtual reality space according to an embodiment.

Referring to FIG. 2, objects placed in a virtual reality space are illustratively shown. In the virtual reality space, an object may be drawn on a plane represented as a card 210. The object may be drawn by a user and may have various shapes. The card 210 may represent an area including the object, and is illustratively shown as a rectangle in FIG. 2, but is not limited to the foregoing example, and may have various shapes. The card 210 may be vertical to the bottom of the virtual reality space shown in the form of a grid at the bottom of FIG. 2, but embodiments are not limited thereto, and may also be horizontal to the bottom as described below. A stand 220 of the card 210 may be a circle centered in the center of the card 210 when projected onto the bottom of the virtual reality space, but not limited to the foregoing example. The stand 220 may be placed on the bottom of the virtual reality space. As described below, different control operations may be performed depending on whether the user inputs a touch gesture on the object 210, on the stand 220, or on an area other than the object 210 or the stand 220. This will be described in detail with reference to the drawings.

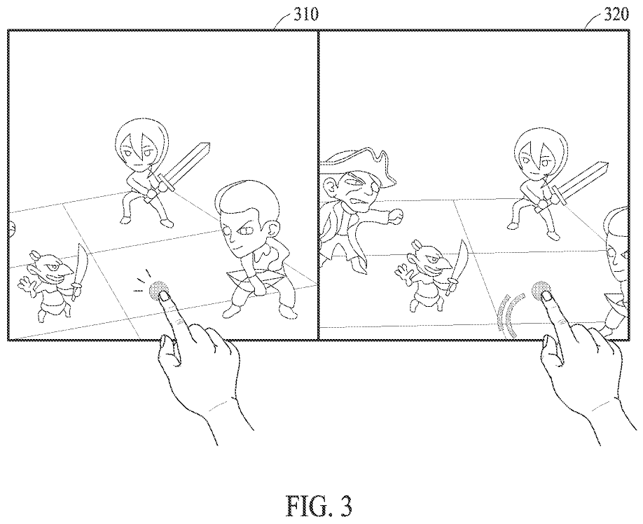

FIGS. 3 to 5 are examples of operations related to camera manipulation according to an embodiment.

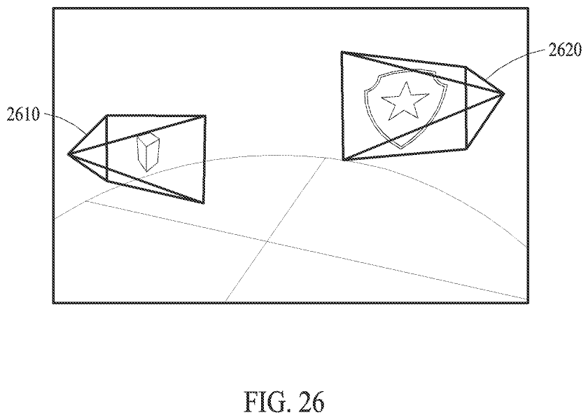

The display of the electronic device 110 of FIG. 1 may display a screen according to a corresponding view frustum within a virtual reality space. A view frustum is a virtual structure corresponding to a camera viewpoint to determine a screen to be provided to a user in a virtual reality space, which is described in detail with reference to FIG. 26. The user may control the screen displayed on the display of the electronic device by controlling the position and/or angle of the view frustum through one or more touch gestures.

Referring to FIG. 3, control of a view frustum based on a single touch gesture is illustratively shown. In operation 310, a user may touch a display of an electronic device with one finger. In operation 320, the user may move the finger to another position on the display, with the finger touching the display. In summary, the user may input a drag gesture with one finger, and an operation of rotating the viewing direction from the fixed camera viewpoint may be performed accordingly. For example, the position of the view frustum within the virtual reality space may not change, and the viewing direction of the view frustum may rotate according to the dragging direction.

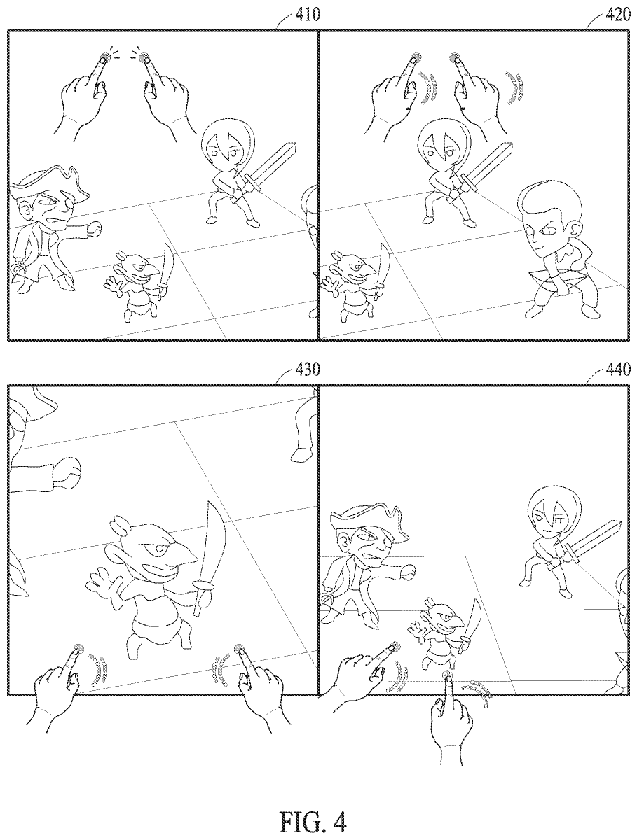

Referring to FIG. 4, control of a view frustum based on two touch gestures is illustratively shown. In operation 410, a user may touch a display of an electronic device with two fingers.

In operation 420, the user may move the two fingers to other positions on the display in parallel, with the fingers touching the display. In other words, the user may input a drag gesture that maintains the distance between the two fingers at a predetermined level, and an operation of moving the camera viewpoint in parallel in the dragging direction may be performed accordingly. For example, the position of the view frustum within the virtual reality space may move in parallel in the dragging direction.

In operation 430, the user may move the two fingers to other positions on the display in the direction that the two fingers are moving away from each other, with the fingers touching the display. In other words, the user may input a drag gesture that increases the distance between the two fingers, and an operation of moving the camera viewpoint forward may be performed accordingly. This operation may increase the size of an object displayed on the display. For example, the position of the view frustum within the virtual reality space may move forward from the viewing direction. Conversely, when the user inputs a drag gesture that decreases the distance between the two fingers, an operation of moving the camera viewpoint backward may be performed accordingly. This operation may decrease the size of an object displayed on the display, and cause an object located behind the view frustum and not displayed on the display to be displayed on the display in response to moving the view frustum.

In operation 440, the user may move the two fingers to other positions on the display so that the angle formed by the two fingers may be changed, with the fingers touching the display. In other words, the user may input a drag gesture that changes the angle formed by the two fingers, and an operation of rotating the camera viewpoint may be performed accordingly. For example, the view frustum within the virtual reality space may rotate. For example, the rotation may be performed relative to a point within the virtual reality space, but is not limited to the foregoing example.

The touch gestures described above may be input independently or in combination, and moving and rotating the view frustum may be performed independently or in combination accordingly.

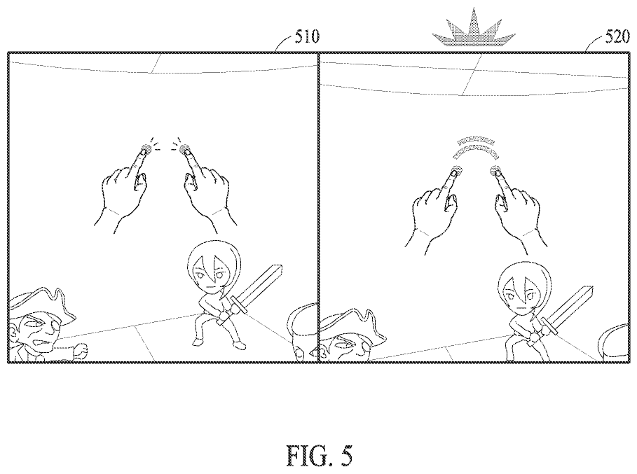

Referring to FIG. 5, an example of limitation by a boundary of a virtual reality space is shown. Depending on the embodiment, the size and shape of the virtual reality space may be predetermined, and the boundary may be set according to the size and shape. For example, the size and shape of the virtual reality space may be set by a user or a system. Moving and/or rotating a view frustum within the virtual space based on the one or more touch gestures described above may be performed within a preset boundary within the virtual reality space. For example, when a user touches a display of an electronic device with two fingers in operation 510 and moves the two fingers in a direction over the boundary of the virtual reality space in operation 520, moving the view frustum may be limited to be within the boundary, and feedback indicating that moving and/or rotating the view frustum is limited by the boundary may be provided to the user. The feedback may be provided in various forms, such as visual, auditory, and tactile forms.

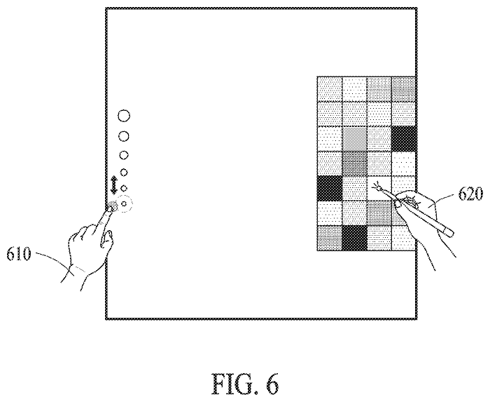

FIGS. 6 to 11 are examples of operations related to object generation according to an embodiment.

Referring to FIG. 6, examples of a touch gesture 610 and a pen input 620 to sketch an object are shown.

An interface for adjusting the pen thickness may be displayed on one side of the display of the electronic device 110 of FIG. 1. A user may control the pen thickness through the touch gesture 610. For example, the touch gesture 610 may drag up and down buttons showing the pen thickness, thereby controlling the pen thickness.

In addition, an interface (e.g., a palette) for controlling the pen color may be displayed on the other side of the display. The square cards shown on the left side of FIG. 6 may represent different colors. The user may select a card of the desired color with a pen tip.

Depending on the embodiment, the user may control the pen thickness through the touch gesture 610 with one hand while controlling the pen color through the pen input 620 with the other hand.

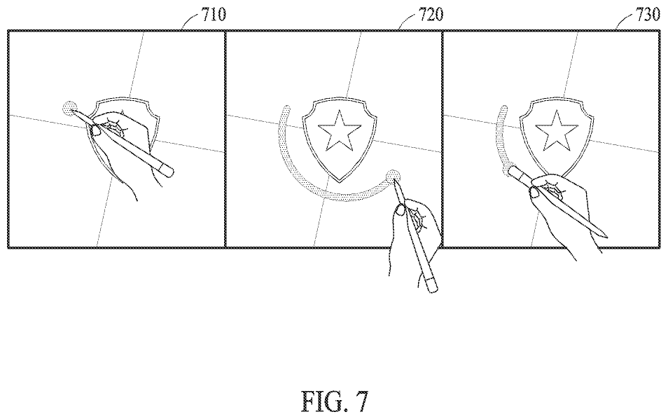

Referring to FIGS. 7, an operation of generating an object is illustratively shown. A user may perform sketching on a screen plane of a view frustum within a virtual reality space by inputting a pen drawing to a display of an electronic device. Operation 710 and operation 720 may illustrate an example of performing sketching on the screen plane of the view frustum based on a pen drawing input to the display and displaying the sketched screen plane on the display. In operation 730, in response to an input to the display with the pen upside down, the sketch of the input portion may be erased.

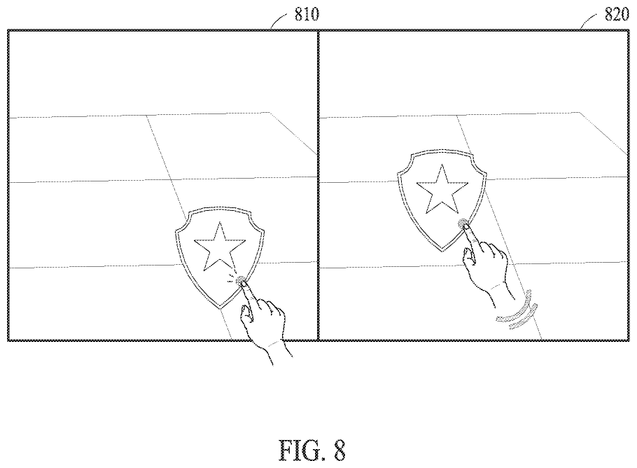

Referring to FIG. 8, control of an object based on a single touch gesture is illustratively shown. In operation 810, a user may touch an object with one finger. In operation 810, the user may move the finger to another position on the display with the finger touching the object. In summary, the user may input a drag gesture with one finger, and moving the selected object may be performed on the screen plane of the view frustum accordingly.

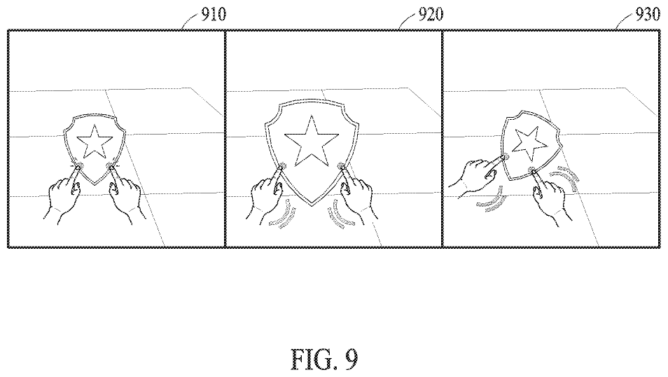

Referring to FIG. 9, control of an object based on two touch gestures is illustratively shown. In operation 910, a user may touch an object with two fingers.

In operation 920, the user may move the two fingers to other positions on the display in the direction that the two fingers are moving away from each other, with the fingers touching the object. In other words, the user may input a drag gesture that increases the distance between the two fingers, and the size of the object may increase accordingly.

In operation 930, the user may move the two fingers to other positions on the display so that the angle formed by the two fingers may be changed, with the fingers touching the object. In other words, the user may input a drag gesture that changes the angle formed by the two fingers, and an operation of rotating the object may be performed accordingly.

In addition, if the user moves the two fingers in parallel to other positions on the display with the fingers touching the object, an operation of moving the object in parallel in the dragging direction may be performed accordingly.

The touch gestures described above may be input independently or in combination, and one or a combination of at least two of moving, rotating, and resizing of the object may be performed accordingly. The moving, rotating, and resizing of the object described above may be performed on the screen plane of the view frustum.

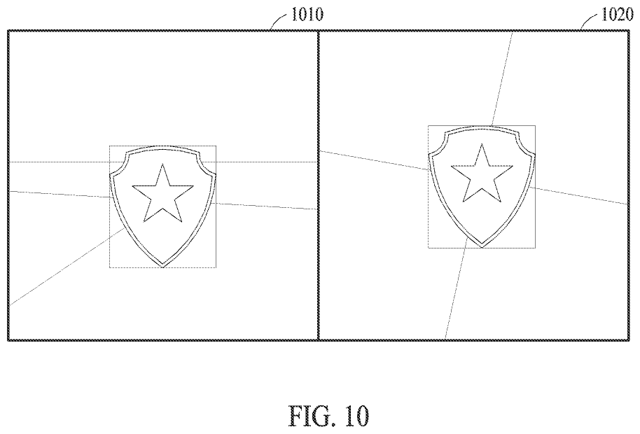

Referring to FIG. 10, an example of an operation of determining the orientation of a projection plane on which an object generated by sketching is to be projected within a virtual reality space is shown. An electronic device may determine the orientation of a projection plane of an object from the viewing direction of a view frustum. For example, the projection plane may be vertical or horizontal to the bottom of the virtual reality space. For example, if the angle formed by the viewing direction of the view frustum and the bottom of the virtual reality space is greater than or equal to a threshold angle (e.g., 45 degrees, etc.), the projection plane may be determined vertically to the bottom. Conversely, if the angle formed by the viewing direction of the view frustum and the bottom of the virtual reality space is less than the threshold angle, the projection plane may be determined horizontally to the bottom. However, the angle of the projection plane is not limited to the foregoing example, and depending on the embodiment, the projection plane may be determined to have various angles with the bottom. Operation 1010 may show an example of a projection plane determined vertically to the bottom, and operation 1020 may show an example of a projection plane determined horizontally to the bottom.

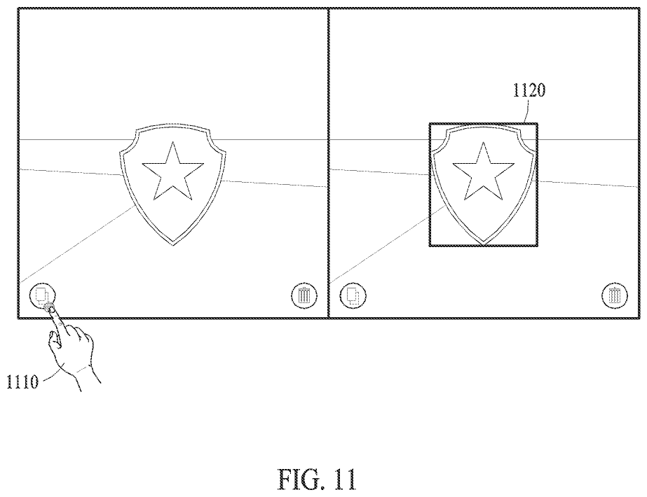

Referring to FIG. 11, an example of generating an object on a projection plane based on a button displayed on a display of an electronic device is shown. A user may input a command to generate an object into the electronic device by selecting the button displayed on the display with one finger 1110. According to the command to generate, an object may be generated on the projection plane and placed in a virtual reality space. The angle of the projection plane may be determined to be vertical or horizontal to the bottom, and the distance to the projection plane may be determined to touch the bottom, ceiling, or boundary when the sketched object is projected. The description provided with reference to FIG. 10 may apply to the operation of determining the projection plane, and thus, a further detailed description thereof is omitted. A card 1120 including the object placed on the projection plane may be displayed.

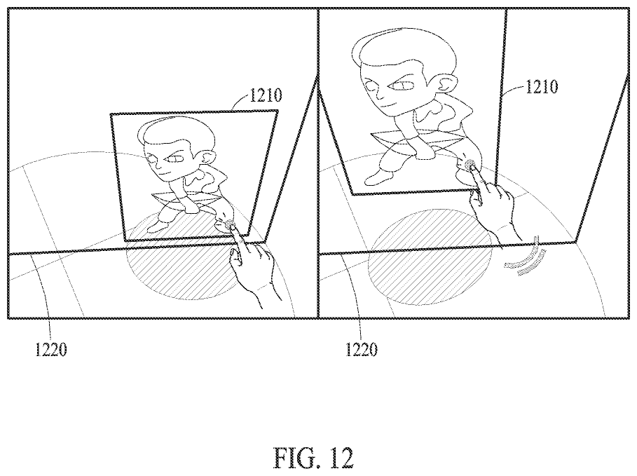

FIGS. 12 to 17 are examples of operations related to an object generated vertically to the bottom of a virtual reality space according to an embodiment.

Referring to FIG. 12, control of an object based on a single touch gesture on a card 1210 is illustratively shown. First, a user may touch the card 1210 including the object placed in a virtual reality space with one finger. When a touch gesture on the card 1210 including the placed object is input, a first reference plane 1220 may be displayed based on the card 1210. The first reference plane 1220 may be a plane that includes the card 1210 and is larger than the card 1210. For example, the first reference plane 1220 may be a large plane that is expanded to a preset boundary within the virtual reality space. Then, the user may move the finger to another position on the display, with the finger touching the card 1210. In summary, the user may input a drag gesture with one finger, and moving the object in the card 1210 may be performed on the first reference plane 1220 accordingly.

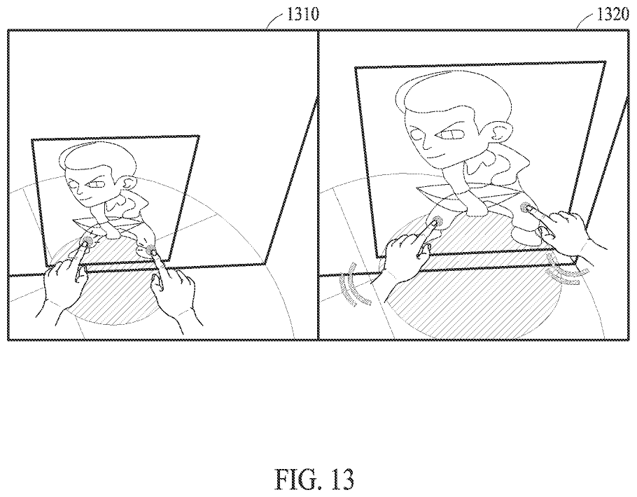

Referring to FIG. 13, control of an object based on two touch gestures on a card is illustratively shown. In operation 1310, a user may touch a card including an object placed in a virtual reality space with two fingers. Similarly, when a touch gesture on the card including the placed object is input, a first reference plane may be displayed based on the card. In operation 1320, the user may move the two fingers to other positions on the display with the fingers touching the card. In summary, the user may input a drag gesture with two fingers, and moving and/or resizing the object in the card may be performed on the first reference plane accordingly.

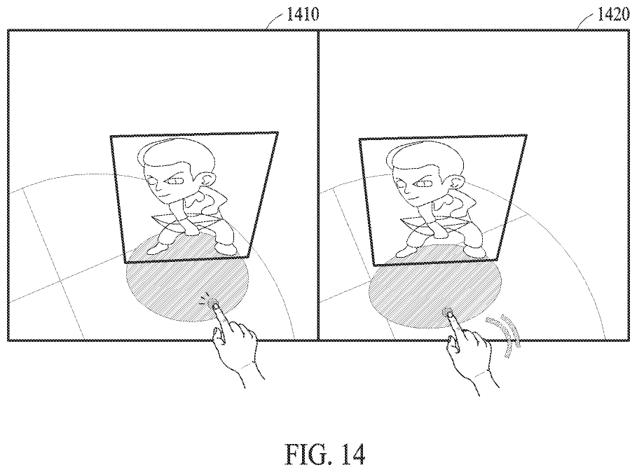

Referring to FIG. 14, control of an object based on a single touch gesture on a stand is illustratively shown. A stand may be generated to be parallel to the bottom of a virtual reality space at the position at which a card including an object placed in the virtual reality space is projected on the bottom. In operation 1410, a user may touch a stand with one finger. By displaying a stand on which a touch gesture is input to be visually different (e.g., to be darker or brighter, etc.) than a stand on which a touch gesture is not input, so that feedback indicating a touch gesture on a stand is accurately input may be provided to the user. In operation 1420, the user may move the finger to another position on the display with the finger touching the stand. In summary, the user may input a drag gesture with one finger, and moving the object corresponding to the stand may be performed on a second reference plane including the stand accordingly. The second reference plane may be a plane that includes the stand and is larger than the stand, and may be, for example, a large plane that is expanded to a predetermined boundary within the virtual reality space. For example, the second reference plane may correspond to the bottom of the virtual reality space.

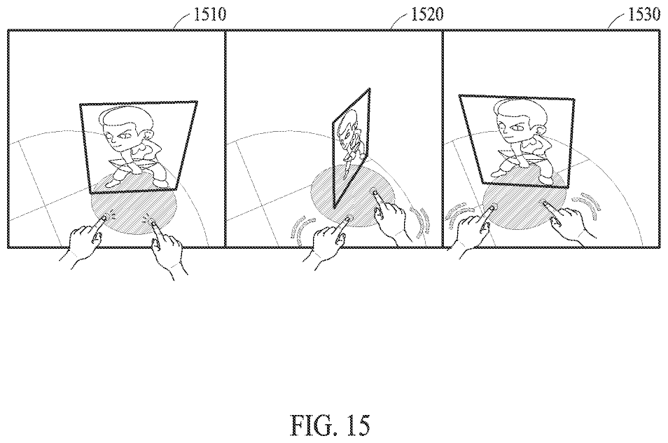

Referring to FIG. 15, control of an object based on two touch gestures on a stand is illustratively shown. In operation 1510, a user may touch a stand with two fingers. In operation 1520, the user may input a drag gesture that changes the angle formed by the two fingers, and rotating the object corresponding to the stand may be performed on the second reference plane accordingly. In operation 1530, the user may input a drag gesture that maintains the distance between the two fingers at a predetermined level, and moving the object corresponding to the stand may be performed on the second reference plane accordingly.

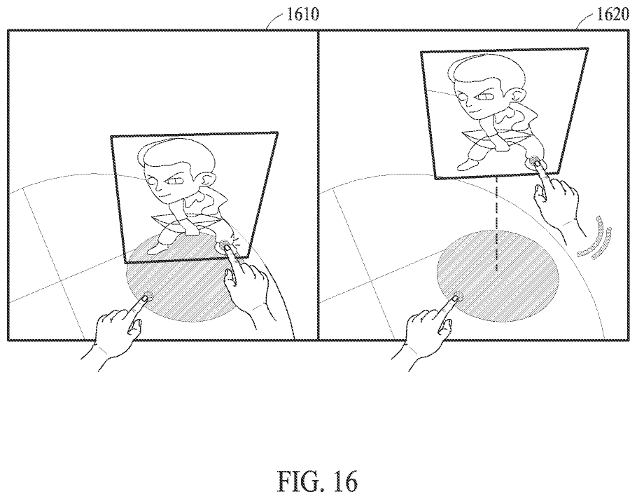

Referring to FIG. 16, control of an object based on two touch gestures on a card and a stand is illustratively shown. In operation 1610, a user may touch a stand of an object placed in a virtual reality space with one finger and touch a card including the object with another finger. In operation 1620, the user may input a drag gesture on the card while maintaining the touch gesture on the stand, and the height of the card within the virtual reality space may be controlled accordingly. For example, the height of the card may be controlled on a first reference plane including the card. The height of the object included in the card may be controlled similarly.

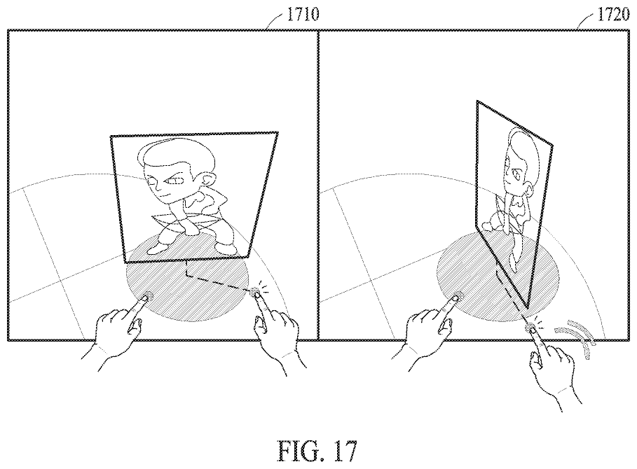

Referring to FIG. 17, control of an object based on two touch gestures on a card and another area is illustratively shown. In operation 1710, a user may touch a stand with one finger and touch an area other than a card or the stand with another finger. In operation 1720, the user may input a drag gesture on the other area while maintaining the touch gesture on the stand, and rotating an object may be performed accordingly.

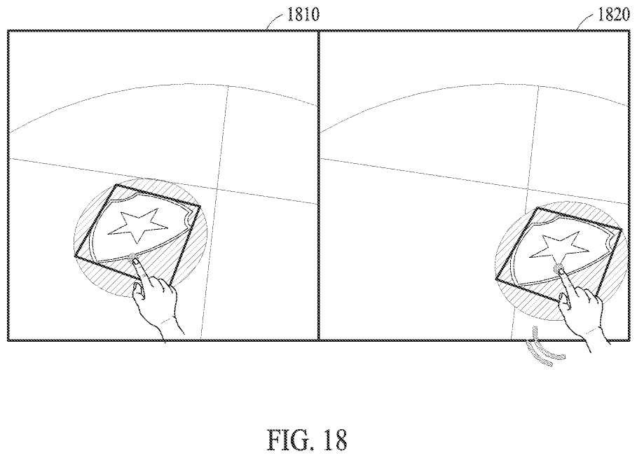

FIGS. 18 to 23 are examples of operations related to an object generated horizontally to the bottom of a virtual reality space according to an embodiment.

Referring to FIG. 18, control of an object based on a single touch gesture on a card is illustratively shown. In operation 1810, a user may touch a card including an object placed in a virtual reality space with one finger. When a touch gesture is input on the card, a first reference plane may be determined based on the card. Since the object is generated horizontally to the bottom, the first reference plane and the bottom may be parallel. In operation 1820, when the user inputs a drag gesture with one finger, moving the object in the card may be performed on the first reference plane accordingly.

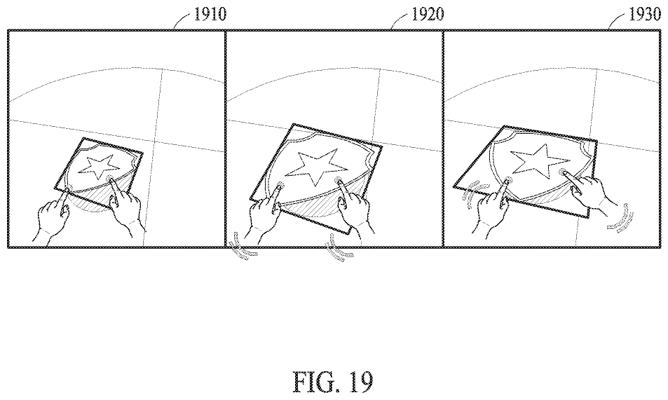

Referring to FIG. 19, control of an object based on two touch gestures on a card is illustratively shown. In operation 1910, a user may touch a card including an object placed in a virtual reality space with two fingers. In operation 1920, when the user inputs a drag gesture with the two fingers (e.g., a gesture that increases or decreases the distance between the two fingers), resizing the object may be performed on the first reference plane accordingly. In operation 1930, when the user inputs a drag gesture with the two fingers (e.g., a gesture that changes the angle formed by the two fingers), rotating the object may be performed on the first reference plane accordingly. In addition, although not shown in FIG. 19, when the user inputs a drag gesture with the two fingers (e.g., a drag gesture that maintains the distance between the two fingers at a predetermined level), moving the object may be performed on the first reference plane accordingly.

The touch gestures with two fingers described above may be input independently or in combination, and one or a combination of at least two of moving, rotating, and resizing of the object may be performed on the first reference plane accordingly.

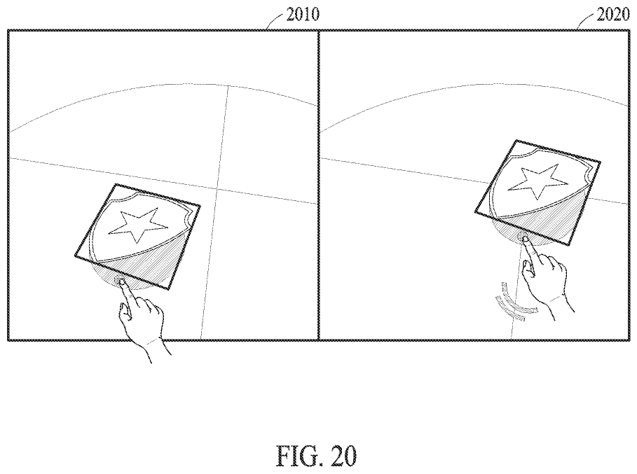

Referring to FIG. 20, control of an object based on a single touch gesture on a stand is illustratively shown. In operation 2010, a user may touch a stand with one finger. By displaying a stand on which a touch gesture is input to be visually different (e.g., to be darker or brighter, etc.) than a stand on which a touch gesture is not input, so that feedback indicating a touch gesture on a stand is accurately input may be provided to the user. In operation 2020, when the user inputs a drag gesture with one finger, moving the object corresponding to the stand may be performed on a second reference plane including the stand accordingly.

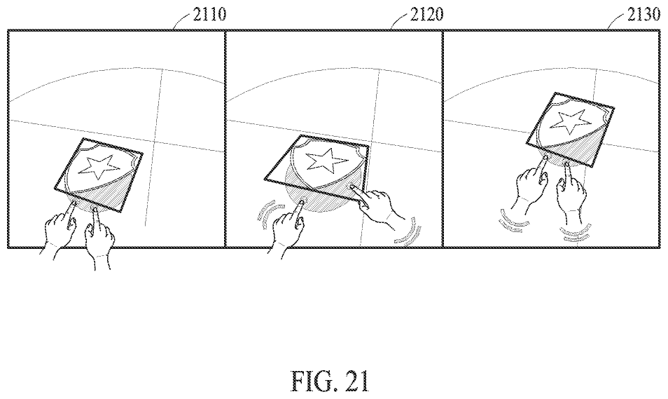

Referring to FIG. 21, control of an object based on two touch gestures on a stand is illustratively shown. In operation 2110, a user may touch a stand with two fingers. In operation 2120, when the user inputs a drag gesture that changes the angle formed by the two fingers, rotating the object corresponding to the stand may be performed on a second reference plane accordingly. In operation 2130, when the user inputs a drag gesture that maintains the distance between the two fingers at a predetermined level, moving the object corresponding to the stand may be performed on the second reference plane accordingly.

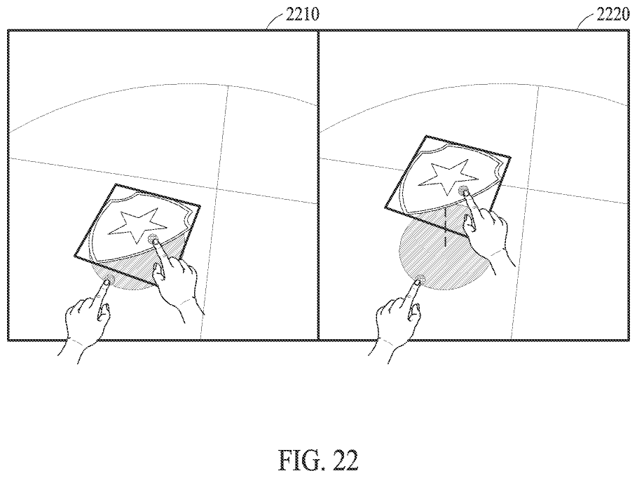

Referring to FIG. 22, control of an object based on two touch gestures on a card and a stand is illustratively shown. In operation 2210, a user may touch a stand of an object placed in a virtual reality space with one finger and touch a card including the object with another finger. In operation 2220, when the user inputs a drag gesture on the card while maintaining the touch gesture on the stand, the height of the card within the virtual reality space may be controlled accordingly. The height of the object included in the card may be controlled similarly.

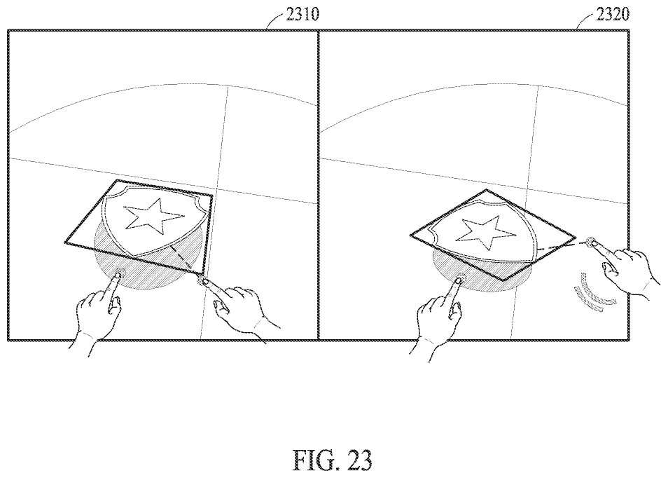

Referring to FIG. 23, control of an object based on two touch gestures on a card and another area is illustratively shown. In operation 2310, a user may touch a stand with one finger and touch an area other than a card or the stand with another finger. In operation 2320, when the user inputs a drag gesture on the other area while maintaining the touch gesture on the stand, rotating an object may be performed accordingly.

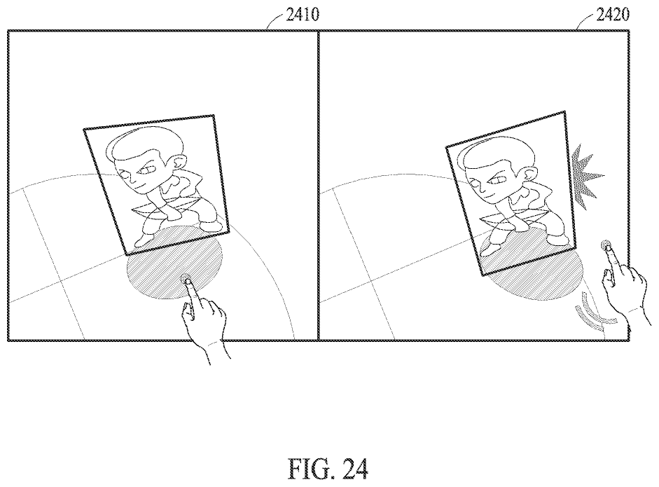

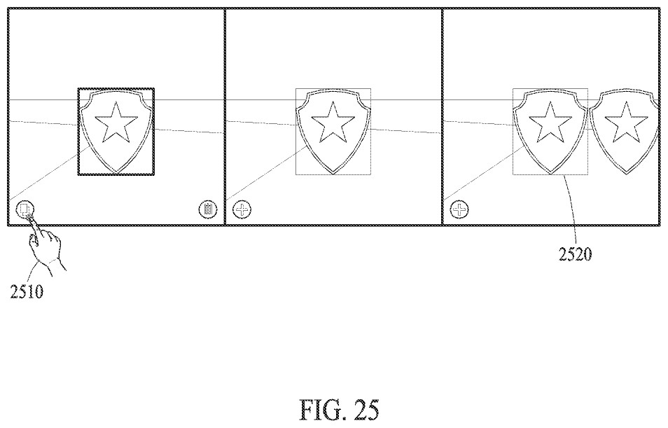

FIGS. 24 and 25 are examples of operations related to the manipulation of a card including an object according to an embodiment.

Referring to FIG. 24, moving, rotating, and resizing an object and a card including the object may be performed within a preset boundary within a virtual reality space. For example, even when the user touches a stand with one finger in operation 2410 and inputs a drag gesture on the stand in operation 2420, moving the object may be limited to be within the preset boundary. Similarly, rotating and resizing the object may also be limited to be within the preset boundary.

Referring to FIG. 25, copying and deleting an object may be performed. When a touch gesture 2510 is input on a copy button displayed on a display while an object in a virtual reality space is selected, the selected object (or a card including the object) may be backprojected, and a copy of the object may be generated on a screen plane of a view frustum. In addition, when the operation related to camera manipulation described above is performed, a copy 2520 may be displayed separately from the existing object according to the operation. Further, a delete button may be present on the display, and when a touch gesture is input on the delete button while an object is selected, the selected object may be deleted from the virtual reality space.

FIG. 26 is an example of an operation related to multiple users according to an embodiment.

Referring to FIG. 26, view frustums 2610 and 2620 of other electronic devices displayed on a display of one electronic device when a plurality of electronic devices access a virtual reality space are illustratively shown. The virtual reality space may be accessed by multiple users at the same time. Each user may view a screen according to a corresponding view frustum through a display of his or her electronic device, and the screen shown in FIG. 26 may be an example displayed on a display of a first electronic device. At this time, the view frustums 2610 and 2620 of second and third electronic devices may be displayed, and when sketching is performed on a screen plane of a corresponding view frustum in the second or third electronic device, a sketched object may be visualized in real time on the display of the first electronic device. In addition, the positions and orientations of the view frustums 2610 and 2620 of the second and third electronic devices may also be visualized in real time based on the camera viewpoint and viewing direction of the second and third electronic devices. This may allow interactions among users within the virtual reality space and thereby provide the users with various experiences.

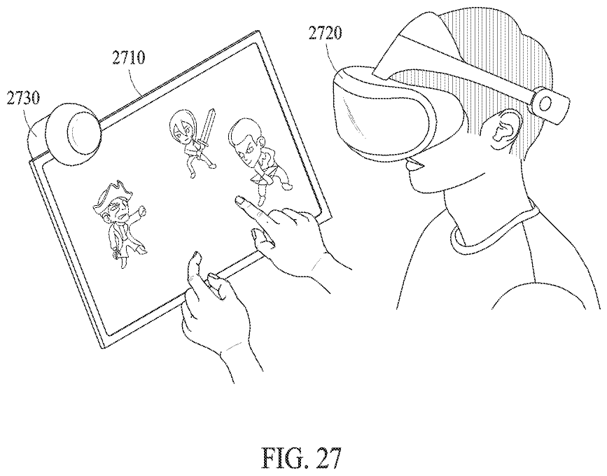

FIGS. 27 to 29 are examples of operations related to an HMD according to an embodiment.

Referring to FIG. 27, a user may control an object in a virtual reality space while wearing an HMD 2720. The HMD 2720 may be worn on the head of the user, and may display a screen of the virtual reality space according to the direction of the head of the user from a viewpoint corresponding to a view frustum within the virtual reality space. The view frustum corresponding to the HMD 2720 may differ from the view frustum corresponding to the electronic device described above, and for ease of description, it may be described that a first view frustum corresponds to the electronic device, and a second view frustum corresponds to the HMD 2720. The first view frustum may be controlled through one or more touch gestures as described above, while the second view frustum may be controlled by the motion of the head of the user wearing the HMD 2720. However, embodiments are not limited thereto, and depending on the embodiment, the first view frustum and the second view frustum may be the same.

Referring to the screen displayed on a display of an electronic device 2710 as a first screen and the screen displayed on the HMD 2720 as a second screen, the first screen may be displayed on the second screen according to the direction of the head of the user. As described in detail below, when the head of the user faces the electronic device 2710, the display of the electronic device 2710 may be displayed on the second screen displayed on the HMD 2720, and the corresponding display may display the first screen on the second screen. To this end, a position difference between the electronic device 2710 and the HMD 2720 may be detected. The positions and/or directions of the electronic device 2710 and the HMD 2720 may be detected through a sensor included in the electronic device 2710 or connected to the electronic device 2710. The position and/or direction of the electronic device 2710 may be detected by a module 2730 placed at a predetermined position in the electronic device 2710, or may be detected based on a marker rather than the module 2730, but is not limited to the foregoing examples, and the position and/or direction of the electronic device 2710 may be detected without a separate module 2730 or marker.

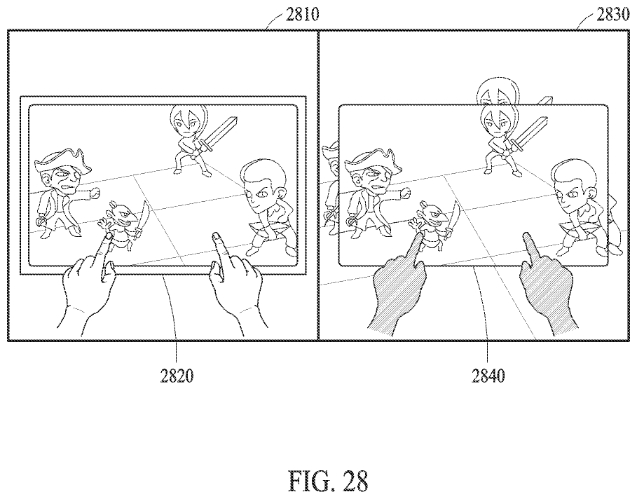

Referring to FIG. 28, operation 2810 shows an example of performing control of an object and/or a first view frustum within a virtual reality space through a first screen displayed on an actual display of an electronic device 2820 by a user not wearing an HMD. The user may perform control of the object and/or the first view frustum based on one or more touch gestures.

Operation 2830 shows an example of a second screen displayed on an HMD when a user is wearing the HMD. A virtual display 2840 of the electronic device 2820 may be displayed on the second screen. The virtual display 2840 may be synchronized with an actual display of the electronic device 2820. The virtual display 2840 may display the first screen displayed on the actual display of the electronic device 2820.

One or a combination of at least two of the size, position, and orientation of the virtual display 2840 of the electronic device 2820 displayed on the second screen may be synchronized with that of the actual display of the electronic device 2820. The hands of the user being tracked may be displayed on the second screen. The user may view his or her hands and the virtual display 2840 displayed on the second screen, and perform a motion of inputting one or more touch gestures described above into the virtual display 2840. Since one or a combination of at least two of the size, position, and orientation of the virtual display 2840 is synchronized with that of the actual display of the electronic device 2820, the virtual display 2840 displays the first screen displayed on the actual display of the electronic device 2820, and the hands of the user being tracked and the virtual display 2840 of the electronic device 2820 are displayed on the second screen, a touch gesture may be input into the actual display with the motion of the user inputting a touch gesture into the virtual display 2840. The user may input, without a sense of difference, a touch gesture into the actual display of the electronic device 2820 while viewing only the second screen displayed on the HMD, which may allow a number of controls to be performed identically based on the touch gestures described above. In addition to the touch gestures, the operations described above may be performed similarly on pen drawings.

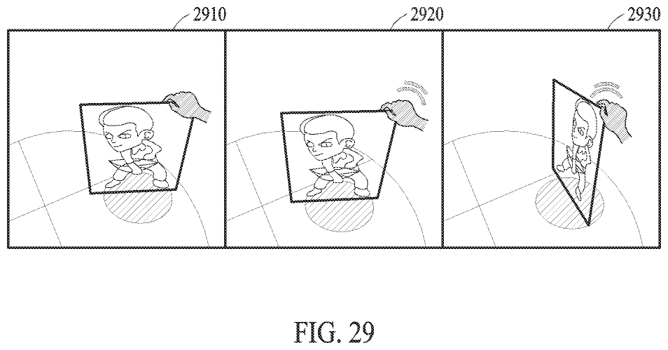

Referring to FIG. 29, an example of controlling an object using a pinch gesture by a user wearing an HMD is shown. In operation 2910, the user may grab a card including an object with a tracked and displayed hand while viewing a second screen displayed on the HMD. In operation 2920, the user may move the hand while grabbing the card, and moving the card including the object may be performed. In operation 2930, the user may rotate the hand while grabbing the card, and rotating the card including the object may be performed accordingly. Although not shown in FIG. 29, the user may grab the card including the object with two tracked and displayed hands while viewing the second screen displayed on the HMD. The user may move and/or rotate both hands while grabbing the card with both hands and change the distance between the two hands, and accordingly, one or a combination of at least two of moving, rotating, and resizing the card including the object may be performed.

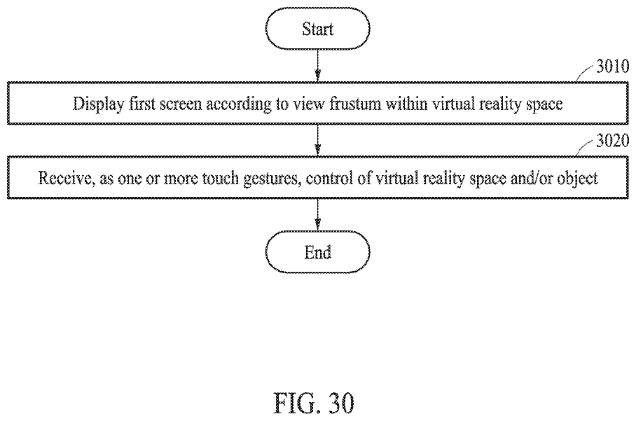

FIG. 30 is a diagram illustrating a method for operating an electronic device according to an embodiment.

Referring to FIG. 30, in operation 3010, an electronic device displays a first screen according to a first view frustum corresponding to the electronic device within a virtual reality space. In operation 3020, the electronic device receives, as one or more touch gestures, control of the virtual reality space and/or an object within the virtual reality space. In response to an HMD being worn on the head of a user who controls the electronic device, the HDM displays a second screen of the virtual reality space according to the direction of the head of the user from a viewpoint corresponding to a second view frustum within the virtual reality space. A virtual display of the electronic device displayed on the second screen according to the direction of the head may be synchronized to an actual display of the electronic device. When the user performs a motion of inputting one or more touch gestures into the virtual display displayed on the second screen, the one or more touch gestures may be input into the actual display of the electronic device so that control of the virtual reality space and/or the object may be performed.

The description provided with reference to FIGS. 1 to 29 may apply to the operations shown in FIG. 30, and thus, a further detailed description thereof is omitted.

The units described herein may be implemented using a hardware component, a software component and/or a combination thereof. A processing device may be implemented using one or more general-purpose or special-purpose computers, such as, for example, a processor, a controller and an arithmetic logic unit (ALU), a digital signal processor (DSP), a microcomputer, a field-programmable gate array (FPGA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described hardware devices may be configured to act as one or more software modules in order to perform the operations of the above-described examples, or vice versa.

A number of embodiments have been described above. Nevertheless, it should be understood that various modifications may be made to these embodiments. For example, suitable results may be achieved if the described techniques are performed in a different order and/or if components in a described system, architecture, device, or circuit are combined in a different manner and/or replaced or supplemented by other components or their equivalents.

Accordingly, other implementations are within the scope of the following claims.

1. An electronic system comprising:
an electronic device configured to receive, as one or more touch gestures, control of a virtual reality space and/or an object within the virtual reality space, and display a first screen according to a corresponding first view frustum within the virtual reality space; and
a head-mounted display (HMD) configured to be worn on a head of a user and to display a second screen of the virtual reality space according to a direction of the head of the user from a viewpoint corresponding to a second view frustum within the virtual reality space, wherein
a virtual display of the electronic device displayed on the second screen according to the direction of the head is synchronized to an actual display of the electronic device, and
when the user performs a motion of inputting one or more touch gestures into the virtual display displayed on the second screen, the one or more touch gestures are input into the actual display of the electronic device so that control of the virtual reality space and/or the object is performed.

2. The electronic system of claim 1, wherein
the virtual display of the electronic device displayed on the second screen displays the first screen displayed on the actual display of the electronic device.

3. The electronic system of claim 1, wherein
one or a combination of at least two of a size, a position, and an orientation of the virtual display of the electronic device displayed on the second screen is synchronized with that of the actual display of the electronic device.

4. The electronic system of claim 1, wherein
a hand of the user being tracked is displayed together with the virtual display of the electronic device on the second screen, and a touch gesture is input into the actual display with a motion of the user inputting the touch gesture into the virtual display.

5. The electronic system of claim 1, wherein
the electronic device is configured to perform moving and/or rotating the first view frustum within the virtual reality space based on the one or more touch gestures input from the user, and
the moving and/or rotating of the first view frustum is performed within a preset boundary within the virtual reality space.

6. The electronic system of claim 1, wherein
the electronic device is configured to perform a sketch on a screen plane of the first view frustum within the virtual reality space based on a pen drawing input into the actual display, and display the sketched screen plane as the first screen.

7. The electronic system of claim 6, wherein
the electronic device is configured to perform one or a combination of at least two of moving, rotating, and resizing the object on the screen plane based on one or more touch gestures on an object generated by the sketch.

8. The electronic system of claim 6, wherein
the electronic device is configured to determine a projection plane of an object generated by the sketch based on a viewing direction of the first view frustum when performing the sketch.

9. The electronic system of claim 8, wherein
the electronic device is configured to generate the object on the projection plane and place the generated object in the virtual reality space when a command to generate the object is input from the user.

10. The electronic system of claim 1, wherein
the electronic device is configured to, based on one or more touch gestures on a card comprising an object within the virtual reality space, perform one or a combination of at least two of moving, rotating, and resizing the object on a first reference plane in which the card is included.

11. The electronic system of claim 1, wherein
the electronic device is configured to, based on one or more touch gestures on a stand of a card comprising an object within the virtual reality space, perform moving and/or rotating the object on a second reference plane in which the stand is included, and
the stand is generated to be parallel to a bottom of the virtual reality space at a position at which the card is projected onto the bottom of the virtual reality space.

12. The electronic system of claim 1, wherein
the electronic device is configured to, while a first touch gesture on a stand of a card comprising an object within the virtual reality space is input, control a height of the card within the virtual reality space based on a second touch gesture on the card.

13. The electronic system of claim 1, wherein
the electronic device is configured to, while a first touch gesture on a stand of a card comprising an object within the virtual reality space is input, perform rotating the object based on a second touch gesture on an area other than the card or the stand.

14. The electronic system of claim 1, wherein
one or a combination of at least two of moving, rotating, and resizing the object according to one or more touch gestures input from the user is performed within a preset boundary within the virtual reality space.

15. The electronic system of claim 1, wherein
the first screen and/or the second screen displays a third view frustum corresponding to a second electronic device accessing the virtual reality space in a viewing direction of the third view frustum at a position corresponding to the second electronic device.

16. The electronic system of claim 15, wherein
the first screen and/or the second screen, in response to a sketch being performed on a second screen plane of the third view frustum based on a pen drawing input into an actual display of the second electronic device, displays the sketched second screen plane.

17. The electronic system of claim 1, wherein
the electronic device is configured to, based on one or more pinch gestures on an object placed within the virtual reality space, input from the user wearing the HMD, perform one or a combination of at least two of moving, rotating, and resizing the object.

18. A method for operating an electronic device, the method comprising:
displaying a first screen according to a first view frustum corresponding to the electronic device within a virtual reality space; and
receiving, as one or more touch gestures, control of the virtual reality space and/or an object within the virtual reality space, wherein
in response to a head-mounted display (HMD) being worn on a head of a user who controls the electronic device, the HDM is configured to display a second screen of the virtual reality space according to a direction of the head of the user from a viewpoint corresponding to a second view frustum within the virtual reality space,
a virtual display of the electronic device displayed on the second screen according to the direction of the head is synchronized to an actual display of the electronic device, and
when the user performs a motion of inputting one or more touch gestures into the virtual display displayed on the second screen, the one or more touch gestures are input into the actual display of the electronic device so that control of the virtual reality space and/or the object is performed.

19. A computer-readable storage medium storing a computer program for executing the method of claim 18.
